(19) United States
(12) Patent Application Publication
(10) Pub. No.: US 2026/0006326 A1
(43) Pub. Date: Jan. 1, 2026

(54) FOCUSING DEVICE, CONTROL METHOD THEREOF, AND ELECTRONIC DEVICE

(71) Applicant: CANON KABUSHIKI KAISHA, Tokyo (JP)

(72) Inventor: NAOKI IWASAKI, Kanagawa (JP)

(21) Appl. No.: 19/237,496

(22) Filed: Jun. 13, 2025

(30) Foreign Application Priority Data
Jun. 27, 2024 (JP) 2024-104351

(51) Int. Cl. H04N 23/67

(52) U.S. Cl. CPC H04N 23/675; H04N 23/671

(57) ABSTRACT

Disclosed is a focusing device that performs focus adjustment of an imaging optical system so that a subject area detected from a captured image is in focus. the focusing device sets a plurality of areas for calculating a defocus amount as areas in an image and selects an area to be used for focus adjustment from the plurality of areas. The focusing device then performs focus adjustment of the imaging optical system based on the defocus amount calculated for the area to be used for focus adjustment. The focusing device sets the plurality of areas in a range encompassing the subject area. In a case where the subject area is smaller than a predetermined size, the focusing device sets the range that is narrower than in a case where the subject area is not smaller than the predetermined size.

### BACKGROUND

### Field of the Technology

The present disclosure relates to a focusing device, a control method thereof, and an electronic device.

### Description of the Related Art

An image capture apparatus that detects a characteristic area, such as a person's face, from a captured image, and performs automatic focus adjustment so that the detected characteristic area is in focus has been known in the art (Japanese Patent No. 7154758).

Advances in detection technology have made it possible to detect a small characteristic area (e.g., a face area).

Accordingly, for example, when performing focus adjustment to bring the detected characteristic area into focus, the characteristic area could be smaller than a focus detection area set for the characteristic area. In this case, the focus detection area includes not only the characteristic area but also the background area. Since the distance of the background differs significantly from that of the subject in the characteristic area, the accuracy of focus adjustment when the focus detection area includes a background area is likely to be degraded.

Another example of a scene that includes small subjects to be captured may be a scene includes multiple athletes. In this case, since multiple characteristic areas (e.g., face areas) are detected, there is a risk that the athlete to be in focus may be mistakenly switched from the intended one to another.

### SUMMARY

An embodiment of the present disclosure provides a focusing device and a control method thereof that can mitigate one or more of issues of the prior art by improving the accuracy of automatic focus adjustment for small characteristic areas.

According to an aspect of the present disclosure, there is provided a focusing device that performs focus adjustment of an imaging optical system so that a subject area detected from a captured image is in focus, comprising: one or more processors that execute a program stored in a memory and thereby function as: a setting unit configured to set a plurality of areas for calculating a defocus amount as areas in an image; a selection unit configured to select an area to be used for focus adjustment from the plurality of areas; and an adjustment unit configured to perform focus adjustment of the imaging optical system based on the defocus amount calculated for the area to be used for focus adjustment, wherein the setting unit sets the plurality of areas in a range encompassing the subject area, and wherein in a case where the subject area is smaller than a predetermined size, the setting unit sets the range that is narrower than in a case where the subject area is not smaller than the predetermined size.

According to another aspect of the present disclosure, there is provided an electronic device comprising: an image sensor; a detection unit configured to detect a subject area from an image captured using the image sensor; and a focusing device that performs focus adjustment of an imaging optical system so that a subject area detected from a captured image is in focus, wherein the focusing device comprises: one or more processors that execute a program stored in a memory and thereby function as: a setting unit configured to set a plurality of areas for calculating a defocus amount as areas in an image; a selection unit configured to select an area to be used for focus adjustment from the plurality of areas; and an adjustment unit configured to perform focus adjustment of the imaging optical system based on the defocus amount calculated for the area to be used for focus adjustment, wherein the setting unit sets the plurality of areas in a range encompassing the subject area, and wherein in a case where the subject area is smaller than a predetermined size, the setting unit sets the range that is narrower than in a case where the subject area is not smaller than the predetermined size.

According to a further aspect of the present disclosure, there is provided a control method performed by a focusing device that performs focus adjustment of an imaging optical system so that a subject area detected from a captured image is in focus, comprising: setting a plurality of areas for calculating a defocus amount as areas in an image; selecting an area to be used for focus adjustment from the plurality of areas; and performing focus adjustment of the imaging optical system based on the defocus amount calculated for the area to be used for focus adjustment, wherein the setting includes setting the plurality of areas in a range encompassing the subject area and setting, in a case where the subject area is smaller than a predetermined size, the range that is narrower than a range in a case where the subject area is not smaller than the predetermined size.

According to another aspect of the present disclosure, there is provided a non-transitory computer-readable medium storing a program, which when executed by one or more processors of a focusing device that performs focus adjustment of an imaging optical system so that a subject area detected from a captured image is in focus, causes to the focusing device to perform a control method comprising: setting a plurality of areas for calculating a defocus amount as areas in an image; selecting an area to be used for focus adjustment from the plurality of areas; and performing focus adjustment of the imaging optical system based on the defocus amount calculated for the area to be used for focus adjustment, wherein the setting includes setting the plurality of areas in a range encompassing the subject area and setting, in a case where the subject area is smaller than a predetermined size, the range that is narrower than a range in a case where the subject area is not smaller than the predetermined size.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram showing an example of the functional configuration of a digital camera to which the focusing device according to an embodiment is applied.

FIG. 2 is a flowchart relating to the operation of a digital camera according to an embodiment.

FIG. 3 is a flowchart relating to the operation of a digital camera according to an embodiment.

FIGS. 4A to 4D are to describe the AF frame setting process in an embodiment.

FIG. 5 is a flowchart relating to the operation of a digital camera according to an embodiment.

FIG. 6 is a flowchart relating to the operation of a digital camera according to an embodiment.

FIG. 7 is a flowchart relating to the operation of a digital camera according to an embodiment.

FIG. 8 is a schematic diagram of a histogram used in an embodiment.

FIG. 9 is a flowchart relating to the operation of a digital camera according to an embodiment.

FIG. 10 shows an example of a prediction curve used in an embodiment.

FIG. 11 is to describe erroneous tracking prevention control according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the following, an embodiment in which a focusing device according to present disclosure is implemented in a digital camera will be described. However, the focusing device can be implemented in any electronic device having an image capture function. Such electronic devices include video cameras, computing devices (personal computers, tablet computers, media players, PDAs, etc.), smart phones, smart watches, game consoles, robots, drones, drive recorders, etc. These are examples and the focusing device can be implemented in other electronic devices.

### Configuration of a digital camera

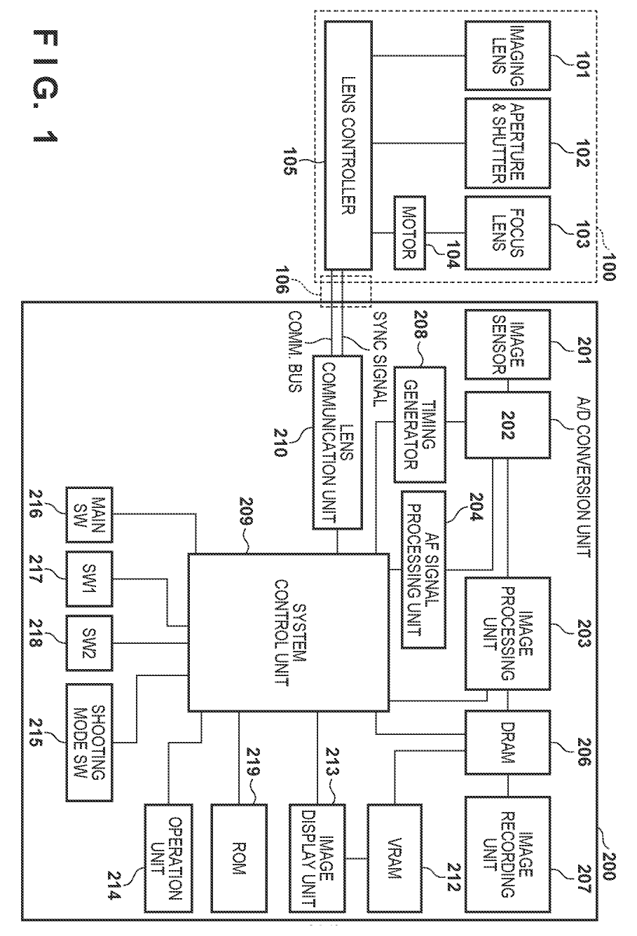

FIG. 1 is a block diagram showing an example of the functional configuration of a digital camera (hereinafter simply referred to as "camera") to which a focusing device according to an embodiment of the present disclosure can be applied. The camera is composed of a lens unit (interchangeable lens) 100 and a camera body 200. Here, a lens-interchangeable camera in which the lens unit 100 can be attached to and detached from the camera body 200. However, the lens unit 100 may be fixed to the camera body 200.

Each of the lens unit 100 and the camera body 200 has a mount unit. The mount units are removably engaged. The lens unit 100 is attached to the camera body 200 by engaging the mount unit of the lens unit 100 with the mount unit of the camera body 200. The electrical contact unit 106 includes a group of electrical contacts provided opposite each other on the mount unit of the lens unit 100 and the mount unit of the camera body 200.

When the lens unit 100 is attached to the camera body 200, the group of electrical contacts in the electrical contact unit 106 make contact and power is supplied from the camera body 200 to the lens unit 100. In addition, the lens unit 100 (a lens controller 105) and the camera body 200 (a system control unit 209) can communicate with each other through the group of electrical contacts being contacted.

The lens unit 100 includes an imaging lens 101, an aperture 102 that controls the amount of light, a focus lens 103, a motor 104 that drives the focus lens 103, and a lens controller 105. The imaging lens 101 and the focus lens 103 constitute the imaging optical system that forms a subject image on the imaging surface of an image sensor 201. In the present embodiment, the aperture 102 shall also serve as a mechanical shutter. The imaging optical system may include a lens that changes the focal length (angle of view) of the lens unit 100 and an image stabilization (IS) lens.

The camera body 200 comprises the image sensor 201. The image sensor 201 may be, for example, a known CCD or CMOS color image sensor with a primary color Bayer array color filter. The image sensor 201 includes a pixel array in which a plurality of pixels are arranged in two dimensions, and peripheral circuits for reading out signals from each pixel. Each pixel accumulates electric charge corresponding to the amount of incident light by photoelectric conversion. By reading out from each pixel a signal with a voltage corresponding to the amount of electric charge accumulated during the exposure period, a group of pixel signals (analog image signals) representing the subject image formed on the imaging surface is obtained.

In this embodiment, each pixel of the image sensor 201 has one microlens and a photoelectric conversion region divided into multiple photoelectric conversion areas. From each pixel, signals can be selectively read out from the multiple photoelectric conversion areas. Here, the photoelectric conversion region is divided into two equal areas, and the individual photoelectric conversion areas are designated as photodiodes (or sub-pixels) A and B. For a plurality of pixels in an arbitrary rectangular area of the pixel array, the analog image signals read from photodiodes A (A signals) and the analog image signals read from photodiodes B (B signals) form a parallax image pair.

The A and B signals read from multiple pixels in a rectangular area set as the focus detection area can be used to obtain the defocus amount in the focus detection area. Therefore, the A and B signals are also called focus detection signals. On the other hand, a signal obtained by adding the A and B signals for each pixel (A+B signal) can be handled in the same way as a signal obtained from a pixel whose photoelectric conversion region is not divided, and is therefore also called the captured image signal. The A signal (or B signal) may be generated by subtracting the B signal (or A signal) from the A+B signal.

The A/D conversion unit 202 has a circuit that applies preprocessing to the analog image signal obtained from the image sensor 201 and a circuit applies A/D conversion to the signal to which preprocessing has been applied. The preprocessing may be, for example, correlated double sampling (CDS) and nonlinear amplification. The A/D conversion unit 202 outputs digital data (image data) after A/D conversion to an image processing unit 203 for the A+B signals. The A/D conversion unit 202 outputs the digital data (image data) after A/D conversion to the AF signal processing unit 204 for the A signals and the B signals. When the A or B signal is generated using the A+B signal, the A/D conversion unit 202 also outputs the A+B signals to the AF signal processing unit 204.

The AF signal processing unit 204 calculates the phase difference (the amount of image shift) between the A and B signals. The AF signal processing unit 204 further calculates the defocus amount (and defocus direction and reliability) of the imaging optical system from the amount of image shift. When multiple focus detection areas are set, the AF signal processing unit 204 performs these calculation processes for each focus detection area (AF frame).

A ROM 219 is a rewritable nonvolatile memory that stores programs to be executed by the system control unit 209, various settings of the camera body 200, GUI data, etc.

An image processing unit 203, by applying predetermined image processing to the image data output from the A/D conversion unit 202, generates signals and/or image data corresponding to the application and obtains and/or generates various types of information. The image processing unit 203 may be, for example, a dedicated hardware circuit such as an application specific integrated circuit (ASIC) designed to achieve a specific function. Alternatively, the image processing unit 203 may be configured to achieve a specific function by a processor such as a digital signal processor (DSP) of a graphics processing unit (GPU) executing software. The image processing unit 203 outputs the obtained or generated information and data to the system control unit 209, the DRAM 206, and the like according to the application.

The image processing applied by the image processing unit 203 can include, for example, pre-processing, color interpolation processing, correction processing, detection processing, data processing, evaluation value calculation processing, special effects processing, and so forth.

The pre-processing can include reference level adjustment, defect pixel correction, etc.

The color interpolation processing is performed when the image sensor 201 is equipped with a color filter. The color interpolation processing interpolates the values of color components that are not included in the individual pixel data comprising the image data. Color interpolation processing is also called demosaicing.

The correction processing can include white balance adjustment, tone correction, correction of image degradation caused by optical aberrations of the imaging optical system (image recovery), correction of the influence of limb darkening of the imaging optical system, color correction, etc.

The detection processing can include detection of a characteristic area (e.g., a specific subject area) and movement thereof, and recognition of people, etc.

The data processing can include cutting out of an image area (cropping), compositing, scaling, encoding and decoding, header information generation (data file generation), etc. Generation of image data for display and image data for recording is also included in the data processing.

The evaluation value calculation processing can include generating evaluation values for automatic exposure control (AE).

The special effects processing can include adding bokeh effects, changing color tones, re-lighting, etc.

These are examples of processing that can be applied by the image processing unit 203, and are not limited to the processing applied by the image processing unit 203.

In this embodiment, the image processing unit 203 can detect human, animal (dog, cat, bird, etc.), and transportation (airplane, train, ship, car, motorcycle, bicycle, etc.) areas as characteristic areas. The image processing unit 203 can detect characteristic areas using any known method. For example, the image processing unit 203 can detect characteristic areas using machine learning models trained according to the type of subject, or using template matching using templates having shapes and patterns characteristic of the subject. These are mere examples, and other known methods may be used. The data used for detecting characteristic areas, such as trained machine learning models and templates, shall be stored in the ROM 219 in advance. For human and animal subjects, the image processing unit 203 shall detect the face (head) area, pupil area, and torso or body area. For automobile, motorcycle, and bicycle subjects, the image processing unit 203 shall detect the vehicle area and the passenger's head or helmet area.

The image processing unit 203 stores identification information (ID), subject type, position and size in the image, and detection reliability in the DRAM 206 for each of the characteristic areas as detection results. The size of the characteristic area may be, for example, the horizontal and vertical size (the number of pixels) of a rectangular area circumscribed to the subject area. The image coordinates of one vertex of this rectangular area (e.g., the top left vertex) can be used as the position of the characteristic area in the image.

The DRAM 206 is used as a main memory of the system control unit 209, a buffer to temporarily store the captured image data, a work memory to temporarily store data being processed by the image processing unit 203, etc.

The VRAM 212 is a video memory that stores image data for display to be displayed on the image display unit 213.

The image recording unit 207 comprises a recording medium, such as a memory card, for example, and an interface circuit for accessing the recording medium. Image data for recording is recorded on the recording medium by the image recording unit 207. The recording medium is not limited to a removable medium such as a memory card, but can also be a recording medium built into the camera body 200.

The timing generator 208 provides each unit of the camera body 200 with a clock signal that serves as a reference for operation timing.

The lens communication unit 210 supplies a synchronization (SYNC) signal to the lens unit 100. The system control unit 209 communicates bidirectionally with the lens controller 105 on a communication bus established between the lens controller 105 and the lens communication unit 210.

The image display unit 213 is, for example, a color liquid crystal display (LCD) provided on the surface of the camera body 200. The image display unit 213 displays captured images, playback images, menu screens, and information about the settings and status of the digital camera. During the shooting standby state, by continuously performing movie recording, generating image data for display, and displaying the data on the image display unit 213, the image display unit 213 is made to function as an electronic viewfinder (EVF). The series of operations to make the image display unit 213 function as an EVF are called live view display operations, and the moving image to be displayed is called a live view image.

The shooting mode switch (SW) 215 is a switch for selecting one of the multiple shooting modes selectable on the camera body 200. Each of the shooting mode is defined according to the scene or subject to be captured. For example, the shooting modes include a night scene mode, a sports mode, a portrait mode, etc. When a shooting mode is selected, several items, such as a F-number, shutter speed, ISO sensitivity, auto focus adjustment operation mode, and image processing details, are changed to settings appropriate for the shooting mode.

The main SW 216 is a power switch that turns the power of the digital camera on and off.

SW1 217 and SW2 218 are switches that are turned on by half-pressing and full-pressing the release button, respectively. The system control unit 209 recognizes SW1 on as an instruction to prepare for capturing a still image and SW2 on as an instruction to start capturing a still image.

The operation unit 214 is a generic term for input devices (buttons, switches, dials, etc.) provided for the user to input various instructions to the camera body 200, other than the switches 215-218 described above. The operation unit 214 includes a movie recording switch, a menu button, directional keys, a decision key, etc. The system control unit 209 recognizes the video recording switch as an instruction to start recording a moving image when the switch is pressed during the shooting standby state, and as an instruction to stop recording of the moving image when the switch is pressed during recording of a moving image. The input devices may include a software button or key using a touch display. The operation unit 214 may also include an input device that supports non-contact input methods such as voice input or eye gaze input.

Among the components of the camera body 200 described above, the image processing unit 203, the AF signal processing unit 204, and the system control unit 209 realize a focus adjustment device.

### Operation of the Digital Camera

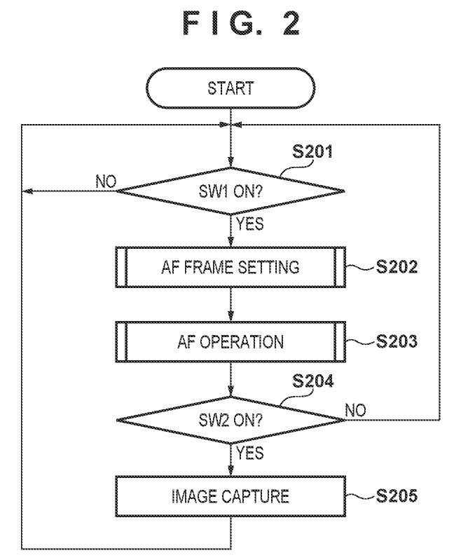

Next, the operation of the digital camera when capturing a still image is explained using the flowchart shown in FIG. 2. The operation starts when the power of the camera body 200 is turned on by the main SW216 and the camera body 200 enters the shooting standby state. It is assumed that in the shooting standby state, the system control unit 209 controls each unit of the digital camera to perform the live view display operation.

In S201, the system control unit 209 determines whether SW1 217 is ON or not. The system control unit 209 performs S202 if it is determined that SW1 217 is ON, and otherwise repeatedly performs S201.

In S202, the system control unit 209 sets a focus detection area (an AF frame) and notifies the AF signal processing unit 204 of the AF frame. The details of the process are described below.

In S203, the system control unit 209 executes an automatic focusing operation (AF operation) that drives the focus lens 103 based on the defocus information obtained from the AF signal processing unit 204. The details of the process are described below. The system control unit 209 also determines exposure conditions (a F-number, a shutter speed, and an ISO sensitivity) based on evaluation values obtained from the image processing unit 203 and settings such as an exposure mode. Since the exposure conditions can be determined using any method known as automatic exposure control (AE), a detailed explanation is omitted.

In S204, the system control unit 209 determines whether SW2 218 is ON or not. The system control unit 209 performs S205 if it is determined that SW2 218 is ON, and otherwise repeatedly performs the process from S201. If it is not determined that SW2 218 is ON, the system control unit 209 may repeatedly perform S204 if SW1 217 remains on, and if SW1 217 is turned off, the system control unit 209 may repeatedly perform the process from S201.

In S205, the system control unit 209 controls the operation of each unit to perform capturing and recording operations for a still image. When the recording of still image data by the image recording unit 207 is completed, the system control unit 209 again performs the process from S201. The system control unit 209 may start performing S201 before recording of still image data is completed.

### AF frame setting operation

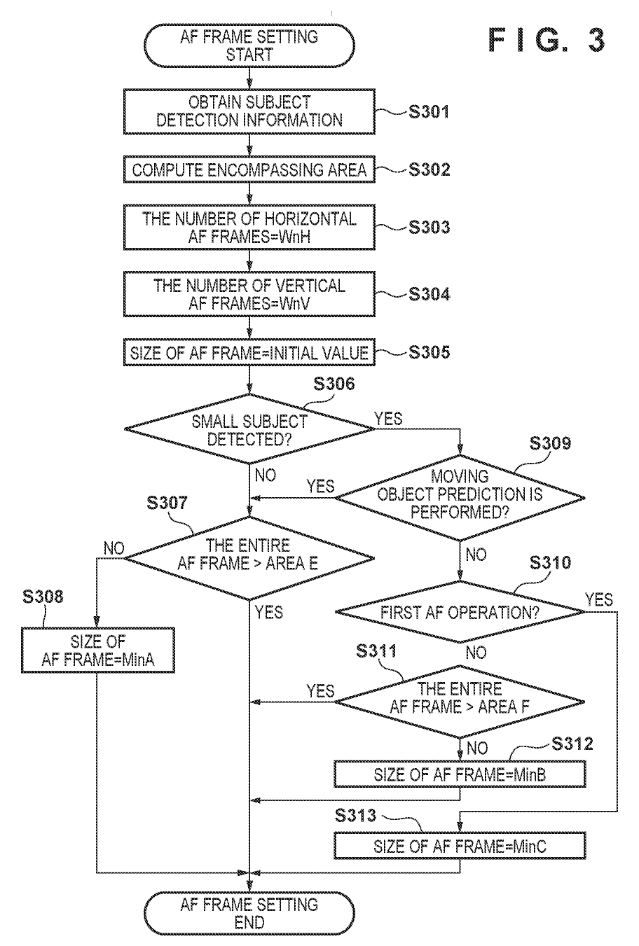

Next, the flowchart shown in FIG. 3 is used to explain the details of the AF frame setting operation in S202 of FIG. 2.

During the shooting standby state, the image processing unit 203 generates image data for display used in the live view display operation and continuously applies subject detection processing to the image data for display. The image processing unit 203 continuously updates the data stored in the DRAM 206 so that the results of the subject detection processing for the most recent predetermined number of times are stored in the DRAM 206. As an example, it is assumed that the characteristic areas to be detected by the subject detection processing are eyes, face, and torso or body of human or animal.

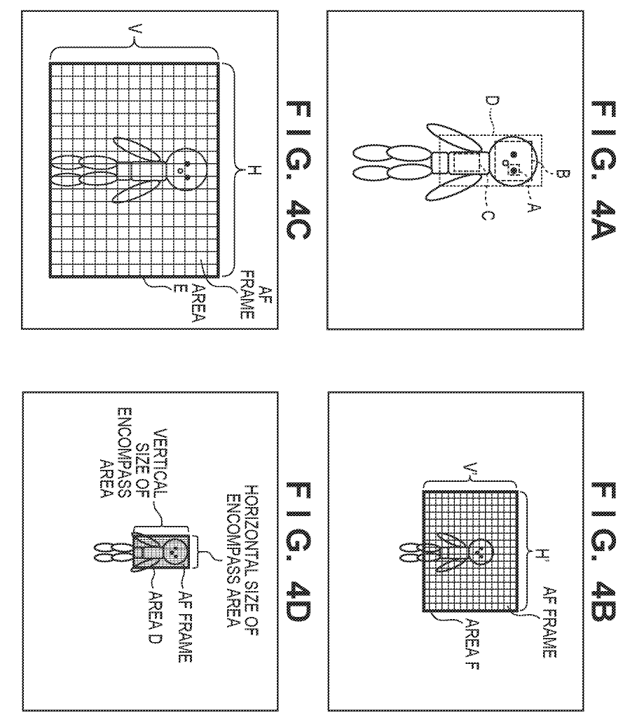

In S301, the system control unit 209 obtains the results of the subject detection processing from the DRAM 206. Here, it is assumed that a pupil area A, a face area B, and a torso area C of the same human subject are detected, as shown in FIG. 4A. Here, it is assumed that the parts are of the same subject because a single area is detected for each part, but if multiple areas for the same kind of part are detected, parts of the same subject can be determined based on, for example, the relationship among the detected positions of different parts.

In S302, the system control unit 209 determines an area D that encompasses the entire detected pupil area A, face area B, and torso area C. Since the area D encompasses the pupil area A, face area B, and torso area C of the same subject, the area D corresponds to the subject area. The area D may be a rectangular area circumscribed to the pupil area A, face area B, and torso area C. As shown in FIG. 4A, the area D may be an area that is slightly enlarged of the rectangular area circumscribed to the pupil area A, face area B, and torso area C, taking into account the subject's movement and detection errors in the characteristic areas.

In S303, the system control unit 209 sets the number of horizontal AF frames to WnH.

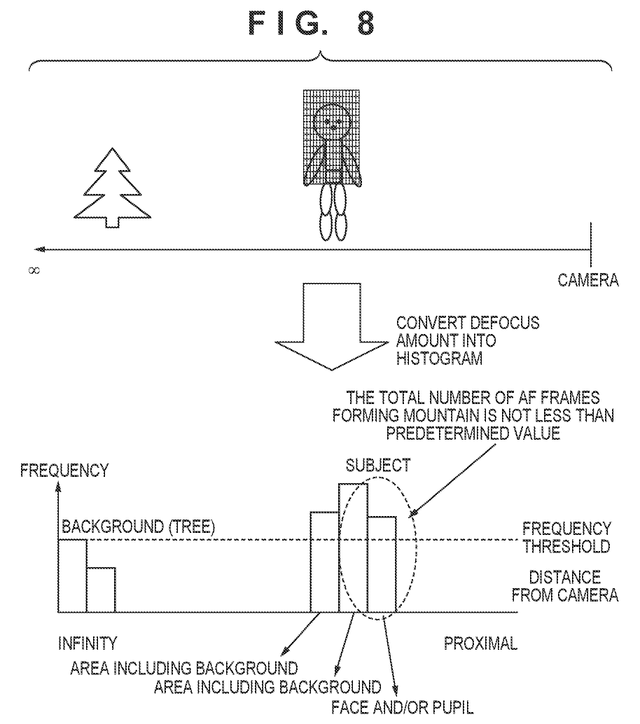

In S304, the system control unit 209 sets the number of vertical AF frames to WnV. WnH and WnV are integers of 2 or more, such that the product of WnH and WnV, or the total number of AF frames, exceeds a predetermined threshold value (for example, tens to hundreds). The threshold value can be determined so that the accuracy of subject identification using a histogram of defocus amounts, which is described later using FIG. 8, is sufficient.

In S305, the system control unit 209 sets the size of the AF frame to the initial value (the reference value). More specifically, the system control unit 209 sets the size of the AF frame according to the following equation. Initial value of AF frame size (integer) = size of long side of area D × predetermined magnification A / the number of AF frames

Where the number of AF frames is WnV if the area D is vertically long and is WnH when the area D is horizontally long. The predetermined magnification A is a predetermined value greater than or equal to 1, and can take different values depending on the AF operation mode (e.g., depending on whether single-shot AF or continuous AF).

In S306, the system control unit 209 determines whether or not a subject area whose size on the image is smaller than the predetermined size (hereinafter referred to as a "small subject") is detected. The system control unit 209 performs S309 if it is determined that a small subject is detected, and otherwise repeatedly performs S307. The system control unit 209 can determine that a small subject is detected if, for example, the size of the area corresponding to the subject type in area D is less than the threshold size. The system control unit 209 can determine that a small subject is detected if, for example, the size of the face area for a human subject or the size of the passenger's head or helmet area for a car or motorcycle is less than the threshold size. The threshold size may be the number of pixels, or a percentage (%) when the entire screen is 100%. For example, for a face or head area, the threshold size can be 3 to 4%. The threshold size may be different for different types of subjects. Also, S306 may not need to be performed depending on the type of subject.

In S307, the system control unit 209 determines whether the entire AF frame is larger than a predetermined area E set in the screen indicated by H and V in FIG. 4B. Here, the area E is assumed to be a predefined area whose center coincides with the center of the screen, has the same aspect ratio as the screen, and occupies a predetermined percentage of the entire screen (e.g., about 70% to 80%). This is just an example and may be set according to other conditions. The entire AF frame is the area in which the AF frames of the initial size set in S305 are arranged the number of WnV vertically and WnH horizontally. The system control unit 209 ends the AF frame setting process without changing the size of the AF frame (leaving the size to the initial size) if it is determined that the entire AF frame is larger than the area E. On the other hand, the system control unit 209 performs S308 if it is not determined that the entire AF frame is larger than area E. In S308, the system control unit 209 changes the size of the AF frame from the initial size to the first minimum size MinA and ends the AF frame setting process.

The first minimum size MinA can be defined as a value that allows WnH AF frames in the horizontal direction and WnV AF frames in the vertical direction to be arranged over the entire area of a predetermined size that encompasses the area D. Here, the area of the predetermined size is defined as the area E with size H in the horizontal direction and size V in the vertical direction.

For example, if the AF frames are arranged without gaps in the horizontal and vertical directions, the system control unit 209 can determine the larger of H/WnH and V/WnV as the first minimum size MinA. If the AF frames are arranged with gaps horizontally and vertically, the system control unit 209 can similarly determine the first minimum size MinA using the values obtained by subtracting the size corresponding to the gaps from each of H and V.

In S309, the system control unit 209 determines whether or not the moving object prediction is being performed. The system control unit 209 performs S307 if it determines that the moving object prediction is being performed, and otherwise performs S310. The moving object prediction is the process of predicting the distance of the subject to be in focus (the main subject). Details of the moving object prediction are described below. For example, the system control unit 209 can determine that the moving object prediction is being performed if a history containing the number of prediction results necessary for the moving object prediction is stored. The determination may be based on other conditions.

In S310, the system control unit 209 determines whether or not this is the first AF operation. The system control unit 209 performs S313 if it is determined that this is the first AF operation, and otherwise performs S311. The first AF operation is an AF operation that targets a different area from the previous AF operation. The first AF operation would be the AF operation performed when the subject detection processing result is used for the first time or when the characteristic area to be brought into focus is changed.

In S311, the system control unit 209 determines whether the entire AF frame is larger than the predetermined area F in the screen indicated by H' and V' in FIG. 4C. The system control unit 209 ends the AF frame setting process without changing the size of the AF frame (leaving the size to the initial size) if it is determined that the entire AF frame is larger than area F. On the other hand, the system control unit 209 performs S312 if it is not determined that the entire AF frame is larger than area F.

In S312, the system control unit 209 changes the size of the AF frame from the initial size to the second minimum size MinB and ends the AF frame setting process.

The second minimum size MinB can be defined as a value that allows WnH AF frames in the horizontal direction and WnV AF frames in the vertical direction to be arranged over the entire area of a predetermined size that encompasses the area D. Here, the area of the predetermined size is defined as area F with size H' in the horizontal direction and size V' in the vertical direction.

S311 is performed when it is determined that a small subject is detected. Therefore, the horizontal size H' and vertical size V' of the area of the predetermined size should be smaller than the horizontal size H and vertical size V of the area E used to determine the first minimum size MinA of the AF frame. In other words, H' < H, V' < V, and the area F is smaller than the area E.

In addition, the size of the area F is determined as a size that allows a frequency distribution of defocus amounts to be obtained for a plurality of small subjects, in order to prevent a subject to be focused from being erroneously switched from the intended main subject to another subject when capturing a scene including a plurality of small subjects. The process of suppressing unintended switching of the main subject is described below.

The system control unit 209 can determine the second minimum size MinB in the same way as determining the first minimum size MinA. Therefore, the second minimum size MinB is smaller than the first minimum size MinA. However, it should be determined so that the detection accuracy of the amount of a shift between the A and B signals can be ensured. Note that if any AF frame falls outside the area of the predetermined size when the AF frames of the determined size are arranged without gaps or overlaps in the horizontal and vertical directions, overlaps between adjacent AF frames may be allowed to ensure that no AF frame falls outside the area of the predetermined size.

In S313, the system control unit 209 changes the size of the AF frame from the initial size to the third minimum size MinC and ends the AF frame setting process.

The third minimum size MinC can be defined as a value that allows WnH AF frames in the horizontal direction and WnV AF frames in the vertical direction to be arranged over the entire area D (the subject area), as shown in FIG. 4D. The horizontal and vertical sizes of the area D are smaller than the horizontal size H' and vertical size V' of the area F used in determining the second minimum size MinB of the AF frame.

The system control unit 209 can determine the third minimum size MinC in the same way as determining the first and second minimum sizes MinA and MinB. Therefore, the third minimum size MinC is smaller than or equal to the second minimum size MinB. However, it should be determined so that the detection accuracy of the amount of a shift between the A and B signals can be ensured. Note that if any AF frame falls outside the area of the predetermined size when the AF frames of the determined size are arranged without gaps or overlaps in the horizontal and vertical directions, overlaps between adjacent AF frames may be allowed to ensure that no AF frame falls outside the area of the predetermined size.

The system control unit 209 determines the positions of the individual AF frames based on the size and arrangement range of the AF frames determined in S305, S308, S312, or S313. The system control unit 209 then notifies the AF signal processing unit 204 of the size of the AF frame and the positions of the individual AF frames.

In this way, when a small subject is detected, the area where the AF frames are arranged is narrower as well as the size of the AF frame is also smaller than when no small subject is detected. Furthermore, when a small subject is detected and the first AF operation is performed, the area where the AF frames are arranged is narrower as well as the size of the AF frame is smaller than when the second and subsequent AF operations are performed.

Therefore, when a small subject is detected, the detection density of the defocus amount is higher than when no small subject is detected, and thus the separation accuracy between the subject and the background based on the distribution of the defocus amount can be improved. Furthermore, when the first AF operation is performed while a small subject is detected, the AF frame is less likely to include the background, thus enabling highly accurate focus adjustment. The second and subsequent AF operations can be performed by expanding the AF frame arrangement range so that appropriate focus adjustment can continue even when the subject has moved.

According to the present embodiment, the focus adjustment accuracy for a small subject can be improved without increasing the total number of AF frames (i.e., without increasing the computational load) by changing the size of the range in which AF frames are arranged.

### AF Operation

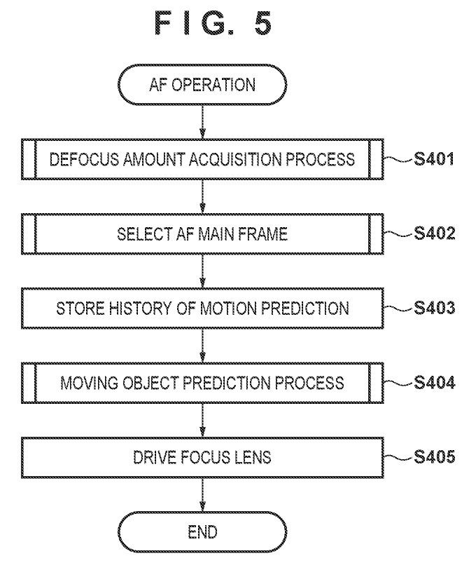

Next, using the flowchart shown in FIG. 5, the details of the AF operation in S203 of FIG. 2 will be explained.

In S401, the AF signal processing unit 204 acquires the defocus amount and its reliability for each AF frame. The details of the operation are described below.

In S402, the system control unit 209 selects the AF frame to be used for focus adjustment (called the AF main frame) based on the defocus amounts acquired by the AF signal processing unit 204 in S401. The details of the operation are described below.

In S403, the system control unit 209 stores the history of the defocus amounts of the AF main frame, including the defocus amount of the AF main frame selected in S402.

In S404, the system control unit 209 performs moving object prediction using the history of defocus amounts. Details of the operation are described below.

In S405, the system control unit 209 drives the focus lens 103 to focus at a distance according to the prediction result in S404.

### Defocus Amount Acquisition Process

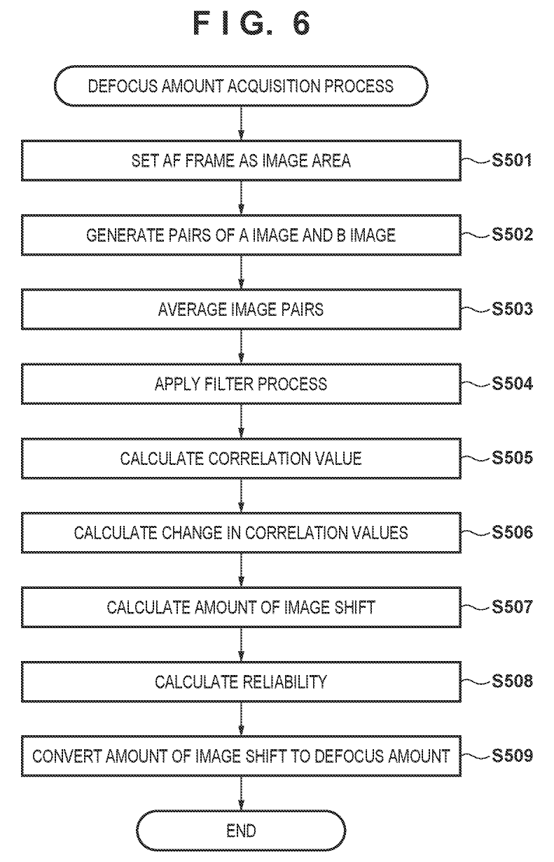

Next, the details of the defocus amount acquisition process in S401 of FIG. 5 are explained using the flowchart shown in FIG. 6.

In S501, the AF signal processing unit 204 sets individual AF frames arranged in the AF frame setting process as areas in the image. For example, when the defocus amounts are detected using the live view image, the AF signal processing unit 204 sets the individual AF frames as areas in the live view image. It is assumed that the A and B signals, or one of the A and B signals and the A+B signal, are read from the image sensor 201.

In S502, the AF signal processing unit 204 generates, for pixels included in each AF frame, a waveform (A image) obtained by concatenating a group of A signals and a waveform (B image) obtained by concatenating a group of B signals, for example, for each horizontal pixel line. As a result, multiple pairs of A and B images are generated for each AF frame.

In S503, the AF signal processing unit 204 converts the multiple A images into a single A image by, for example, adding and averaging them. Similarly, the AF signal processing unit 204 also converts the multiple B images into a single B image. This allows the influence of noise in the A and B images to be suppressed. In this way, the AF signal processing unit 204 obtains a pair of A and B images for each AF frame.

In S504, the AF signal processing unit 204 applies filter processing for extracting signal components of a predetermined frequency band to the pair of A and B images obtained in S503.

In S505, the AF signal processing unit 204 calculates the correlation values in a known manner for the A and B images to which filter processing has been applied while shifting the relative positions of the A and B images.

In S506, the AF signal processing unit 204 calculates the amount of change in the correlation values for the relative positions of the A and B images.

In S507, the AF signal processing unit 204 calculates the amount of image shift where the correlation value between the A and B images is the maximum based on the amount of change in the correlation values.

In S508, the AF signal processing unit 204 calculates the reliability of the calculated image shift amount using any known method.

In S509, the AF signal processing unit 204 converts the image shift amount into a defocus amount by any known method. The defocus amount is assumed to indicate the defocus direction by its sign.

The AF signal processing unit 204 performs process of S504-S509 for each AF frame. The AF signal processing unit 204 stores, for each AF frame, (i) the defocus amount and (ii) the reliability of the image shift amount as the reliability of the defocus amount, in DRAM 206, for example, and then ends the defocus amount acquisition process.

### AF main frame selection process

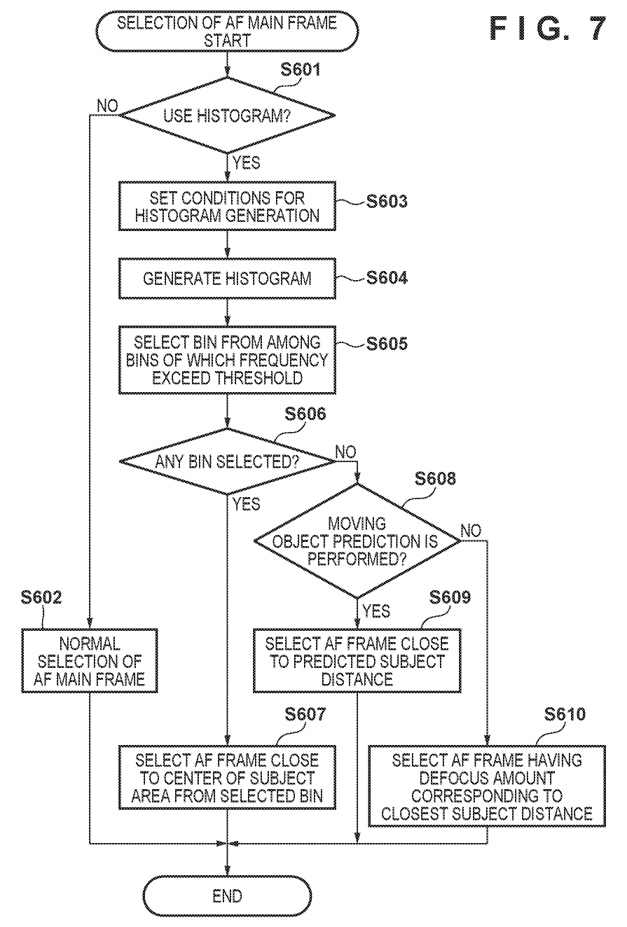

Next, using the flowchart shown in FIG. 7, the details of the AF main frame selection process in S402 of FIG. 5 are explained.

In S601, the system control unit 209 determines whether or not to use a histogram of the defocus amounts (subject distances) for selecting the AF main frame. The system control unit 209 performs S603 if it is determined to use the histogram, and otherwise performs S602. For example, if it is determined in S303 that that a small subject is detected, the system control unit 209 can determine to use the histogram. The histogram may always be used, in which case S601 and S602 are unnecessary.

In S602, the system control unit 209 performs normal selection of an AF main frame (i.e., selecting the AF main frame without using a histogram of defocus amounts). For example, the system control unit 209 selects, as the AF main frame, the AF frame being closest to the center of the subject area and having high reliability of the defocus amount obtained in S508. If the subject distance is predicted by the moving object prediction, the system control unit 209 may select the AF main frame based on the predicted subject distance. For example, the system control unit 209 compares the subject distance corresponding to the defocus amount of the AF frame closest to the center of the subject area with the predicted subject distance. If the difference between the subject distances is greater than or equal to a threshold value, the system control unit 209 selects the AF frame in the subject area with the defocus amount corresponding to the subject distance closest to the predicted subject distance as the AF main frame.

In S603, the system control unit 209 instructs the image processing unit 203 to generate a histogram of the defocus amounts obtained in S401. The image processing unit 203 sets the conditions (the number of bins and the range of object distances corresponding to the individual bins) for generating the histogram. The method of dividing the bins can be predetermined, for example. The width or range of the bins need not be constant.

In S604, the image processing unit 203 converts the defocus amount for each AF frame into the subject distance and generates a histogram.

FIG. 8 is a schematic diagram showing a captured scene and an example of a histogram generated by the image processing unit 203 from the defocus amounts obtained for the captured scene. Based on the defocus amount detected for each AF frame by the AF signal processing unit 204 from the image of the captured scene shown in the upper part, the image processing unit 203 generates the histogram shown in the lower part. The histogram represents the frequency distribution of the defocus amounts for each subject distance range (or the frequency distribution of AF frames for each defocus amount range). The image processing unit 203 generates histogram data that associate bin numbers with frequencies, and stores the histogram data in the DRAM 206.

In S605, the system control unit 209 selects the bin with the smallest (the most proximal) corresponding subject distance range among the bins whose frequency exceeds a predetermined frequency threshold based on the histogram data.

In S606, the system control unit 209 determines whether or not any bin was selected in S605. The system control unit 209 performs S607 if it is determined that a bin was selected and otherwise performs S608. A case where no bin was selected in S605 is, for example, a case where no bin had a frequency that exceeds the frequency threshold.

In S607, the system control unit 209 selects, as the AF main frame, one AF frame that has a distance from the center of the subject area (area D in FIG. 4A) less than a threshold (e.g., the AF frame closest to the center) among the AF frames classified in the selected bin.

In S608, the system control unit 209 determines whether or not a motion prediction is being performed. The system control unit 209 performs S609 if it determined that the moving object prediction is being performed, and otherwise performs S610.

In S609, the system control unit 209 selects, as the AF main frame, one AF frame that has a defocus amount corresponding to a subject distance whose difference from the subject distance predicted by the moving object prediction is less than a threshold among the AF frames that exist in the subject area. For example, the system control unit 209 can select, as the AF main frame, the AF frame whose subject distance corresponding to the defocus amount is closest to the subject distance predicted by the moving object prediction among the AF frames existing in the subject area.

In S610, the system control unit 209 selects, as the AF main frame, the AF frame with the shortest subject distance corresponding to the defocus amount among all AF frames. If a lower limit of the subject distance is set as a condition for generating a histogram, the system control unit 209 selects the AF frame with the shortest subject distance corresponding to the defocus amount above the lower limit as the AF main frame.

If a bin was successfully selected, the AF main frame is selected according to its position in the subject area since a sufficient number of AF frames are considered to be arranged in the subject area. On the other hand, if no bin was selected, it is expected that the number of AF frames arranged in the subject area is insufficient or that a large proportion of AF frames containing background. Therefore, if the motion predicting is being performed, an AF frame having a defocus amount corresponding to a subject distance closer to the predicted subject distance is selected among the AF frames that exist in the subject area. This allows the AF frame that is less likely to be affected by the background to be selected. If the moving object prediction is not performed, an AF frame with the defocus amount corresponding to the subject closer to the camera is selected. This is because in general shooting, a subject close to the camera is often the subject intended by the user.

The above describes a case where a captured scene includes a single subject. However, multiple subject areas of similar size may be detected in a captured scene. For example, for track and field sports, a scene in which multiple athletes are in close proximity may be captured.

FIG. 11 is a schematic diagram showing an example of a result of the subject area detection for a soccer scene including three players in close proximity. In this scenario, it is assumed that the three players are detected as small subjects and that in the AF frame setting process, AF frames are set for the small subjects in S313 during the first AF operation and then AF frames are set for the area F in S312.

For example, suppose that pupil area A, face area B, and torso area C are detected for the main subject and the sub subjects, respectively. If one of the sub subjects crosses in front of the main subject during tracking shooting in which the main subject is continuously focused, the crossing sub subject may be mistakenly recognized as the main subject and thus an unintended switching of the subject to be tracked may occur.

According to the present embodiment, such an unintended switching of the subject to be tracked can be suppressed. First, the system control unit 209 determines the encompassing area described with respect to FIG. 4A for each of the main subject and the sub subjects.

Next, the system control unit 209 determines a representative AF frame for each encompassing area. The representative AF frame may be, for example, the AF frame closest to the center of the encompassing area, or it may be selected from AF frames classified in the bin with the largest frequency in the histogram of the defocus amounts of the AF frames in the encompassing area. Alternatively, as a simplified manner, the representative AF area may be the AF frame with the defocus amount closest to the median of the defocus amounts for the encompassing area.

The system control unit 209 then determines the difference in subject distance from the defocus amount of the representative AF frame determined for each subject. If the difference in subject distance is greater than or equal to a threshold, the system control unit 209 excludes the area of the sub subjects from the tracking target. In other words, the system control unit 209 searches for which area should be tracked for the candidate areas for tracking that exclude obvious different persons using the difference in subject distance. In this way, a sub subject at a distance largely different from the distance of the main subject can be prevented from being mistakenly recognized as the main subject even capturing the scene when the sub subject in the foreground hides the main subject. Therefore, erroneous switching of the AF main frame can be suppressed.

According to the present embodiment, when it is determined that a small subject is detected, smaller AF frames are arranged in a narrower area than when it is not determined that a small subject is detected. Therefore, the separation accuracy between the background and the subject using the histogram of the defocus amounts can be improved compared to the case where the arrangement range and size of the AF frame are not changed. As a result, the possibility that a bin can be selected in S605 when a small subject is detected, i.e., the possibility that an appropriate AF frame can be selected within the subject area, can be improved. Therefore, the main subject can be tracked appropriately even in a scene where multiple small subjects are close together or where the main subject is temporarily hidden by a sub subject among multiple small subjects.

### Moving Object Prediction Processing

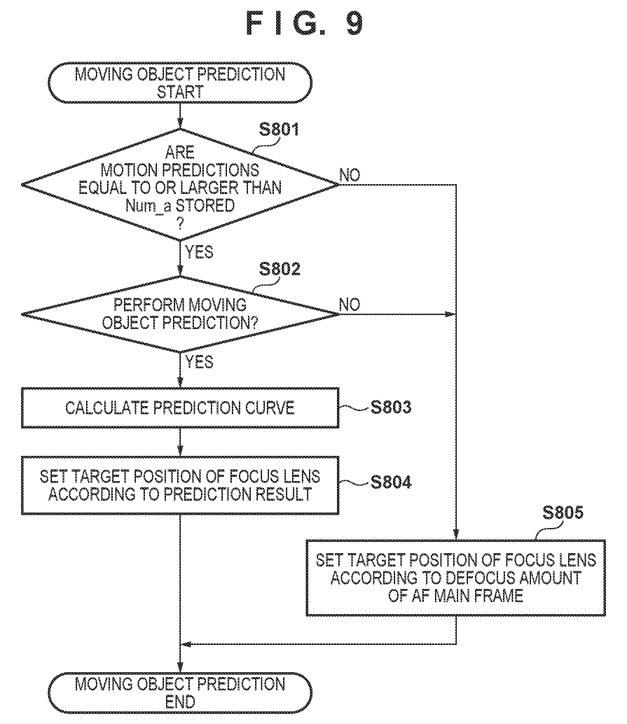

Next, the details of the moving object prediction process in S404 of FIG. 5 are explained using the flowchart shown in FIG. 9.

In S801, the system control unit 209 determines whether or not a history containing a predetermined number Num_a or more of moving object prediction results is stored in DRAM 206. The system control unit 209 performs S802 if it is determined that the history is stored, and otherwise performs S805. The predetermined number Num_a is an integer of 2 or more, and can be determined in advance through experimentation, etc.

In S802, the system control unit 209 determines whether or not to perform moving object prediction. The system control unit 209 performs S803 if it determined to perform the moving object prediction, and otherwise performs S805. Here, as an example, the system control unit 209 shall determine to perform the moving object prediction if, among the stored prediction results (the subject distances), the number of times that the change per a specific unit of time exceeds a threshold is not less than a specified number of times. This is because if the condition is not met, it is expected that the change in distance of the main subject is small and thus the necessity of the prediction is small or it is unsuitable for prediction based on the history. For example, if the moving object prediction is performed periodically, the system control unit 209 can determine to perform the moving object prediction if the history contains a predetermined number or more of prediction results whose difference from the most recent prediction result is greater than a threshold.

In S803, the system control unit 209 generates a prediction curve for predicting a future subject distance based on the history of the prediction results. The system control unit 209 can generate the prediction curve by applying any known method of approximating a curve through multiple points (least-squares method, polynomial interpolation, etc.) to the times at which the moving object predictions were performed and the prediction results.

In S804, the system control unit 209 uses the generated prediction curve to predict the subject distance at the timing of the next AF operation. Then, the system control unit 209 sets the target position for driving the focus lens 103 to a position corresponding to the predicted subject distance. In other words, the system control unit 209 determines the drive amount and drive direction of the focus lens 103 using the current position of the focus lens 103 as the reference.

In S805, the system control unit 209 determines the drive amount and drive direction of the focus lens 103 based on the defocus amount detected in the AF main frame.

### Prediction curve calculation process

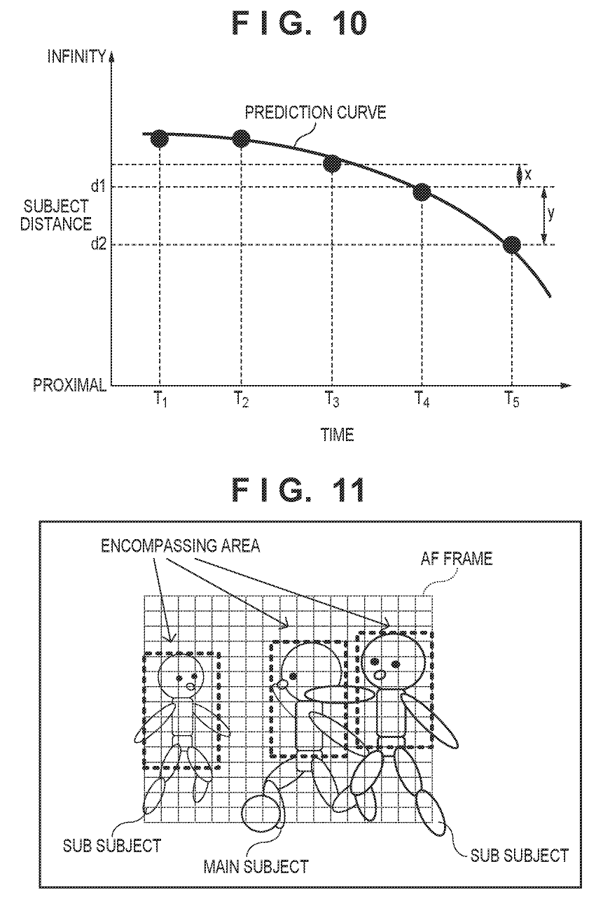

FIG. 10 shows an example of a prediction curve generated based on the history of moving object prediction results stored in S403. The vertical axis represents the subject distance of the main subject area in which the main AF frame is set, obtained as a result of the moving object prediction, and the horizontal axis represents time.

Each of times T₁ to T₅ represents the time when the focus adjustment process (i.e., driving of the focus lens 103) is performed. The subject distances at times T₁ to T₄ are the history of the prediction results, and the next focus adjustment process is to be performed at time T₅.

The prediction curve shown in FIG. 10 indicates that the main subject is approaching toward the camera. The system control unit 209 sets the target position of the focus lens 103 according to the difference between the most recent moving object prediction result and the subject distance at the next focus adjustment execution predicted using the prediction curve. In the example shown in FIG. 10, the system control unit 209 sets the target position of the focus lens 103 at time T₄ to be the position that is in focus at distance d1, based on the difference x between the prediction result for time T₃ and the prediction result for time T₄. Similarly, the system control unit 209 sets the target position of the focus lens 103 at time T₅ to be the position in focus at distance d2 based on the difference y between the prediction results for time T₄ and time T₅.

As explained above, according to the present embodiment, the range in which the AF frames are arranged is dynamically changed according to the size of the detected subject area. Specifically, when a small subject is detected, the range where the AF frames are arranged is to be narrower than when a non-small (normal) subject is detected. The size of the AF frame can also be smaller when a small subject is detected than when a non-small (normal) subject is detected.

By arranging the AF frames in this way, it is possible to obtain a distribution of defocus amounts for a range appropriate for the size of the subject without increasing the total number of AF frames. Therefore, even when the subject is small, the subject and background can be accurately separated based on the distribution of defocus amounts, resulting in accurate focus adjustment on the intended subject.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-104351, filed on June 27, 2024, which is hereby incorporated by reference herein in its entirety.

What is claimed is:

1. A focusing device that performs focus adjustment of an imaging optical system so that a subject area detected from a captured image is in focus, comprising: one or more processors that execute a program stored in a memory and thereby function as: a setting unit configured to set a plurality of areas for calculating a defocus amount as areas in an image; a selection unit configured to select an area to be used for focus adjustment from the plurality of areas; and an adjustment unit configured to perform focus adjustment of the imaging optical system based on the defocus amount calculated for the area to be used for focus adjustment, wherein the setting unit sets the plurality of areas in a range encompassing the subject area, and wherein in a case where the subject area is smaller than a predetermined size, the setting unit sets the range that is narrower than in a case where the subject area is not smaller than the predetermined size.

2. The focusing device according to claim 1, wherein in a case where the subject area is smaller than the predetermined size, the setting unit sets the range to be narrower when the focus adjustment is performed to the subject area for the first time than when the focus adjustment is performed for a second time.

3. The focusing device according to claim 2, wherein setting unit sets the plurality of areas in the subject area when the focus adjustment is performed for the first time.

4. The focusing device according to claim 1, wherein in a case where the subject area is smaller than the predetermined size, the setting unit sets the plurality of areas by allowing partial overlap of adjacent areas.

5. The focusing device according to claim 1, wherein the subject area is an area that encompasses areas of different parts, and wherein the setting unit determines a size of the plurality of areas based on sizes
of the areas of the parts.

6. The focusing device according to claim 1, wherein the selection unit selects the area to be used for focus adjustment from the plurality of areas based on a distribution of defocus amounts calculated for each of the plurality of areas.

7. The focusing device according to claim 1, wherein the selection unit selects the area to be used for focus adjustment from areas that are classified in a bin with a closest subject distance range among bins whose frequency exceeds a frequency threshold in a histogram of the subject distances that correspond to the defocus amounts.

8. The focusing device according to claim 1, wherein in a case where a histogram of subject distances that correspond to the defocus amounts does not have a bin having a frequency that exceeds a frequency threshold and if prediction of the subject distance is being performed, the selection unit selects, from the plurality of areas, an area that corresponds to a subject distance for which a difference from a predicted subject distance is less than a threshold as the area to be used for focus adjustment.

9. The focusing device according to claim 1, wherein in a case where a histogram of subject distances that correspond to the defocus amounts does not have a bin having a frequency that exceeds a frequency threshold and if prediction of the subject distance is not being performed, the selection unit selects, from the plurality of areas, an area corresponding to a closest subject distance as the area used for focus adjustment.

10. An electronic device comprising: an image sensor; a detection unit configured to detect a subject area from an image captured using the image sensor; and a focusing device that performs focus adjustment of an imaging optical system so that a subject area detected from a captured image is in focus, wherein the focusing device comprises: one or more processors that execute a program stored in a memory and thereby function as:
a setting unit configured to set a plurality of areas for calculating a defocus amount as areas in an image;
a selection unit configured to select an area to be used for focus adjustment from the plurality of areas; and
an adjustment unit configured to perform focus adjustment of the imaging optical system based on the defocus amount calculated for the area to be used for focus adjustment,
wherein the setting unit sets the plurality of areas in a range encompassing the subject area, and wherein in a case where the subject area is smaller than a predetermined size, the setting unit sets the range that is narrower than in a case where the subject area is not smaller than the predetermined size.

11. A control method of a focusing device that performs focus adjustment of an imaging optical system so that a subject area detected from a captured image is in focus, comprising: setting a plurality of areas for calculating a defocus amount as areas in an image; selecting an area to be used for focus adjustment from the plurality of areas; and performing focus adjustment of the imaging optical system based on the defocus amount calculated for the area to be used for focus adjustment, wherein the setting includes setting the plurality of areas in a range encompassing the subject area and setting, in a case where the subject area is smaller than a predetermined size, the range that is narrower than a range in a case where the subject area is not smaller than the predetermined size.

12. A non-transitory computer-readable medium storing a program, which when executed by one or more processors of a focusing device that performs focus adjustment of an imaging optical system so that a subject area detected from a captured image is in focus, causes to the focusing device to perform a control method comprising: setting a plurality of areas for calculating a defocus amount as areas in an image; selecting an area to be used for focus adjustment from the plurality of areas; and performing focus adjustment of the imaging optical system based on the defocus amount calculated for the area to be used for focus adjustment, wherein the setting includes setting the plurality of areas in a range
encompassing the subject area and setting, in a case where the subject area is smaller than a predetermined size, the range that is narrower than a range in a case where the subject area is not smaller than the predetermined size.
